(19) United States
(12) Patent Application Publication
(10) Pub. No.: US 2012/0032910 A1
(43) Pub. Date: Feb. 9, 2012

(54) TOUCH PANEL AND METHOD OF MANUFACTURING THE SAME

(75) Inventors: Jae Il Kim, Gyunggi-do (KR); Yong Soo Oh, Gyunggi-do (KR); Jong Young Lee, Gyunggi-do (KR); Woon Chun Kim, Gyunggi-do (KR)

(73) Assignee: SAMSUNG ELECTRO-MECHANICS CO., LTD., Gyunggi-do (KR)

(21) Appl. No.: 12/901,389

(22) Filed: Oct. 8, 2010

(30) Foreign Application Priority Data
Aug. 3, 2010 (KR) 1020100075005

(51) Int. Cl. G06F 3/045; B31B 1/62; B05D 5/12

(52) U.S. Cl. 345/174; 427/108; 156/60; 178/20.01

(57) ABSTRACT

Disclosed herein is a touch panel, including: a transparent substrate; a transparent electrode made of a conductive polymer and formed on one surface of the transparent substrate; an anisotropic conductive adhesion layer formed on an edge of the transparent electrode; and an electrode formed on the anisotropic conductive adhesion layer and electrically connected with the transparent electrode by the anisotropic conductive adhesion layer. The touch panel is advantageous in that the anisotropic conductive adhesion layer is disposed between the transparent electrode and the electrode, so that the chemical reaction between the transparent electrode and the electrode can be prevented, with the result that the resistance between the transparent electrode and the electrode can be maintained constant and the change in physical properties of the transparent electrode can be prevented.

### CROSS REFERENCE TO RELATED APPLICATION

This application claims the benefit of Korean Patent Application No. 10-2010-0075005, filed on Aug. 3, 2010, entitled “Touch panel and a manufacturing method the same”, which is hereby incorporated by reference in its entirety into this application.

### BACKGROUND OF THE INVENTION

1. Technical Field

The present invention relates to a touch panel and a method of manufacturing the same.

2. Description of the Related Art

Development of auxiliary computer devices has taken place alongside the advancement of computers which use digital technology. Personal computers, portable transmitters, and other personal information processing apparatuses carry out the processing of text and graphics using input devices such as keyboards, mice and the like.

However, since computers are gradually being used for various purposes alongside the rapid advance of the information society, there is a problem in that it is difficult to efficiently operate the computers using keyboards and mice which serve as input devices. Therefore, the demand to develop an input device which has a simple structure and does not cause erroneous operations and which can be used to easily input information and data by users is increasing.

Further, input devices must have high reliability, high durability, high innovativeness and high workability in addition to general functionality. In order to accomplish these purposes, a touch panel was developed as an input device capable of inputting information such as text, graphics and the like.

The touch panel is mounted on image display apparatuses, such as flat panel displays including electronic notebooks, liquid crystal displays (LCDs), plasma display panels (PDPs), electroluminescence panels, etc., and cathode ray tubes (CRTs), and is used to enable users to select desired information while viewing an image display apparatus.

Meanwhile, touch panels are classified into resistive touch panels, capacitive touch panels, electromagnetic touch panels, surface acoustic wave (SAW) type touch panels, and infrared touch panels. These various types of touch panels are employed in electronic products in consideration of the problem of signal amplification, the differences of resolution, the difficulty in design and machining techniques, optical characteristics, electrical characteristics, mechanical characteristics, environment-resistant characteristics, input characteristics, durability, and economical efficiency. Currently, among these touch panels, resistive touch panels and capacitive touch panels are the most widely used.

However, conventional resistive touch panels and capacitive touch panels are problematic in that the performance of the touch panels is deteriorated by the chemical reaction between a transparent electrode recognizing touch and a silver (Ag) electrode receiving electrical signals from the transparent electrode. In detail, a solvent included in the silver (Ag) electrode reacts with the transparent electrode made of indium tin oxide (ITO), so that the resistance between the transparent electrode and the silver (Ag) electrode is increased and the physical properties of the transparent electrode are changed, thereby deteriorating the performance of the touch panels. Moreover, conventional resistive touch panels and capacitive touch panels are problematic in that adhesion between the transparent electrode and the silver (Ag) electrode is low, so that the silver (Ag) electrode easily becomes separated from the transparent electrode, thereby deteriorating the durability of the touch panels.

### SUMMARY OF THE INVENTION

Accordingly, the present invention has been devised to solve the above-mentioned problems, and the present invention provides a touch panel which can prevent a chemical reaction from occurring between a transparent electrode and an electrode and which can prevent the electrode from becoming separated from the transparent electrode by employing an anisotropic conductive layer, and a method of manufacturing the same.

An aspect of the present invention provides a touch panel, including: a transparent substrate; a transparent electrode made of a conductive polymer and formed on one surface of the transparent substrate; an anisotropic conductive adhesion layer formed on an edge of the transparent electrode; and an electrode formed on the anisotropic conductive adhesion layer and electrically connected with the transparent electrode by the anisotropic conductive adhesion layer.

Here, the conductive polymer may include poly-3,4-ethylenedioxythiophene/polystyrenesulfonate (PEDOT/PSS), polyaniline, polyacetylene, and polyphenylenevinylene.

Further, the anisotropic conductive adhesion layer may be formed using an anisotropic conductive film (ACF) or an anisotropic conductive adhesive (ACA).

Further, the anisotropic conductive adhesion layer may serve to prevent the transparent electrode and the electrode from directly coming into contact with each other.

Further, the anisotropic conductive adhesion layer may be integrally formed such that it comes into contact with a plurality of patterns of the transparent electrode, and may have electrical conductivity only in a direction perpendicular to the transparent electrode.

Another aspect of the present invention provides a method of manufacturing a touch panel, including: forming a transparent electrode made of a conductive polymer on one surface of a transparent substrate; forming an anisotropic conductive adhesion layer on an edge of the transparent electrode; and forming an electrode on the anisotropic conductive adhesion layer such that the electrode is electrically connected with the transparent electrode by the anisotropic conductive adhesion layer.

Here, in the forming of the transparent electrode, the conductive polymer may include poly-3,4-ethylenedioxythiophene/polystyrenesulfonate (PEDOT/PSS), polyaniline, polyacetylene, and polyphenylenevinylene.

Further, in the forming of the anisotropic conductive adhesion layer, the anisotropic conductive adhesion layer may be formed by applying an anisotropic conductive film (ACF).

Further, in the forming of the anisotropic conductive adhesion layer, the anisotropic conductive adhesion layer may be formed by screen-printing an anisotropic conductive adhesive (ACA).

Further, in the forming of the electrode, the anisotropic conductive adhesion layer may serve to prevent the transparent electrode and the electrode from directly coming into contact with each other.

Further, the anisotropic conductive adhesion layer may be integrally formed such that it comes into contact with a plurality of patterns of the transparent electrode, and may have electrical conductivity only in a direction perpendicular to the transparent electrode.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing a touch panel according to an embodiment of the present invention;

FIG. 2 is a plan view showing a touch panel according to an embodiment of the present invention;

FIG. 3 is a sectional view showing the touch panel taken along the line A-A′ in FIG. 2;

FIGS. 4A and 4B are sectional views showing the touch panel taken along the line B-B′ in FIG. 2;

FIGS. 5 to 7 are perspective views sequentially showing a method of manufacturing a touch panel according to an embodiment of the present invention; and

FIGS. 8 to 10 are sectional views showing touch panels according to other embodiments of the present invention.

### DESCRIPTION OF THE PREFERRED EMBODIMENTS

The objects, features and advantages of the present invention will be more clearly understood from the following detailed description of preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

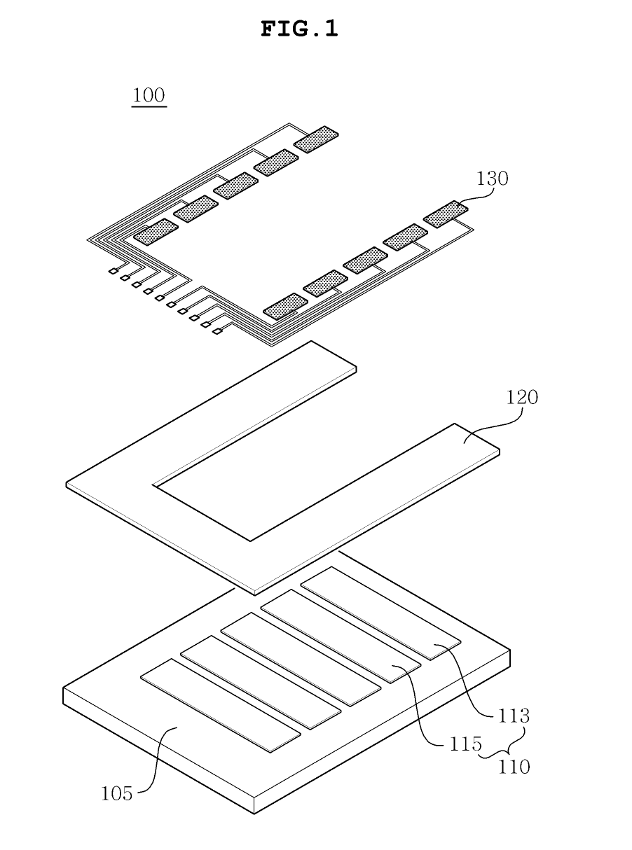

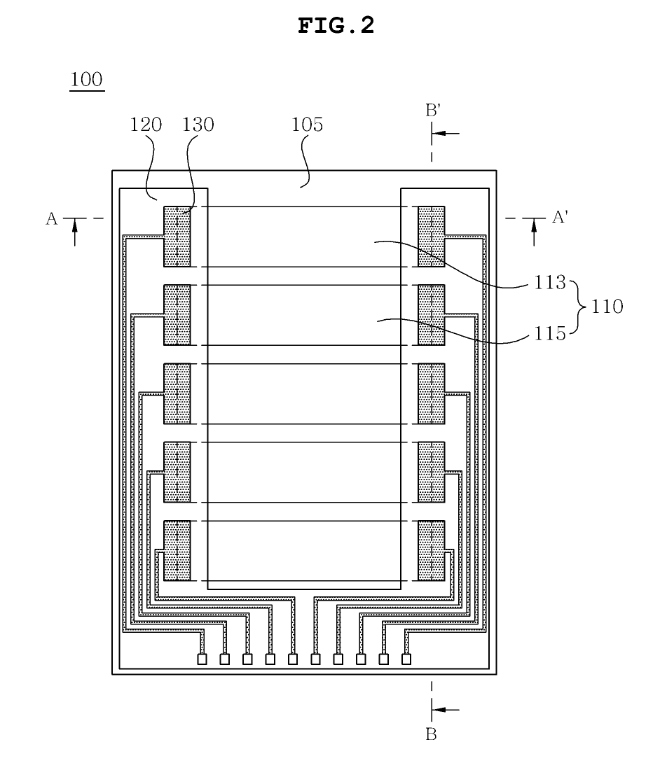

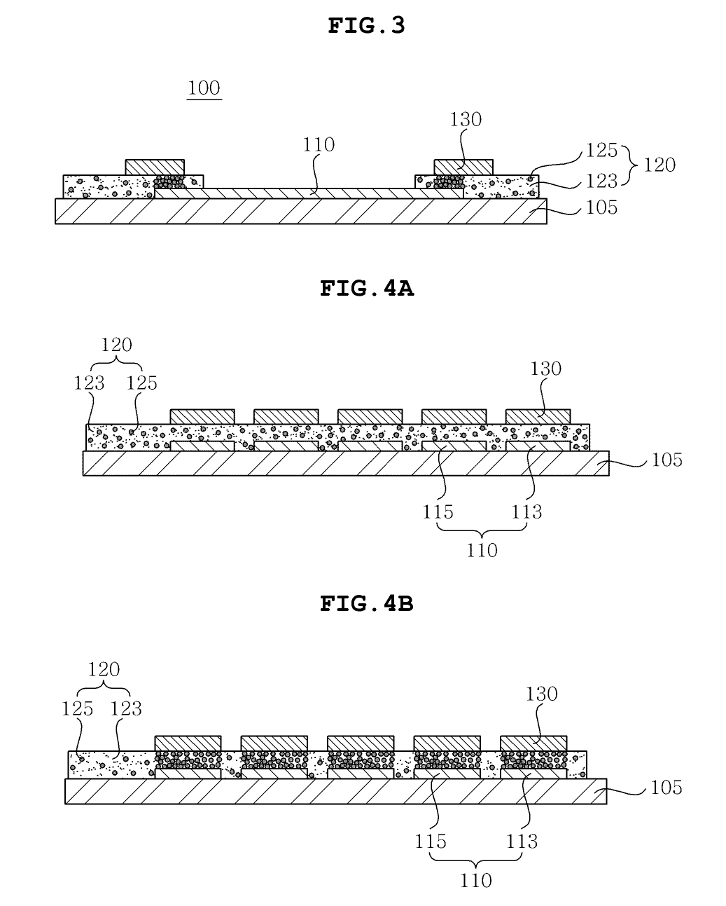

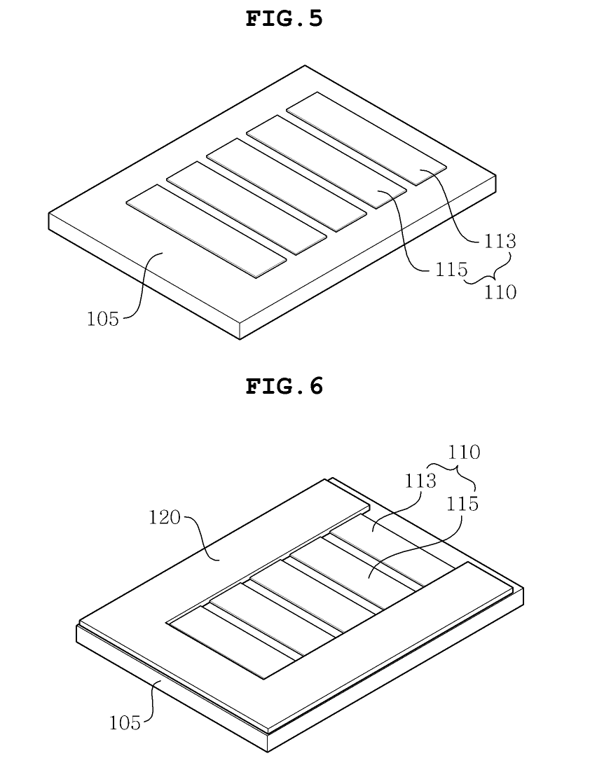

FIG. 1 is an exploded perspective view showing a touch panel according to an embodiment of the present invention, FIG. 1 is a plan view showing a touch panel according to an embodiment of the present invention, FIG. 3 is a sectional view showing the touch panel taken along the line A-A′ in FIG. 2, and FIGS. 4A and 4B are sectional views showing the touch panel taken along the line B-B′ in FIG. 2.

As shown in FIGS. 1 to 4, a touch panel 100 according to an embodiment of the present invention includes: a transparent substrate 105; transparent electrodes 110 made of a conductive polymer and formed on one surface of the transparent substrate 105; an anisotropic conductive adhesion layer 120 formed on the edges of the transparent electrodes 110; and electrodes 130 formed on the anisotropic conductive adhesion layer 120 and electrically connected with the transparent electrodes 110 by the anisotropic conductive adhesion layer 120.

The transparent substrate 105 serves to provide a region for forming the transparent electrodes 110, the anisotropic conductive adhesion layer 120 and the electrodes 130. Therefore, the transparent substrate 105 must be durable such that it can support the transparent electrodes 110, the anisotropic conductive adhesion layer 120 and the electrodes 130 and must be transparent such that users can recognize the images supplied from an image display apparatus. Considering the durability and transparency, the transparent substrate 105 may be made of polyethylene terephthalate (PET), polycarbonate (PC), polymethylmethacrylate (PMMA), polyethylene naphthalate (PEN), polyether sulfone (PES), cycloolefin copolymer (COC), triacetylcellulose (TAC), polyvinyl alcohol (PVA), polyimide (PI), polystyrene (PS), K-resin-containing biaxially-oriented polystyrene (BOPS), glass, reinforced glass, or the like, but the present invention is not limited thereto. Meanwhile, one surface of the transparent substrate 105 may be high-frequency-treated or primer-treated in order to improve adhesion between the transparent substrate 105 and the transparent electrodes 110.

The transparent electrodes 110, which serve to enable a controller to recognize touch coordinates by generating signals when users touch them, are formed on one surface of the transparent substrate 105. Here, the transparent electrodes 110 may be made of a conductive polymer having excellent flexibility and coatability as well as commonly-used indium tin oxide (ITO). The conductive polymer may include poly-3,4-ethylenedioxythiophene/polystyrenesulfonate (PEDOT/PSS), polyaniline, polyacetylene, polyphenylenevinylene, and the like. Meanwhile, in drawings, the transparent electrodes 110 are shown to have bar patterns 113 and 115, but the present invention is not limited thereto. That is, the transparent electrodes 110 may be formed over the entire active region, or may have any kind of pattern known in the related field, such as lozenge patterns, circular patterns and the like.

The anisotropic conductive adhesion layer 120 serves to electrically connect the transparent electrode 110 with the electrodes 130 and to prevent a chemical reaction from occurring between the transparent electrodes 110 and the electrodes 130. That is, the anisotropic conductive adhesion layer 120 is disposed between the transparent electrodes 110 and the electrode 130, so that it is possible to prevent the transparent electrodes 110 and the electrode 130 from directly coming into contact with each other, thereby preventing the occurrence of a chemical reaction between the transparent electrodes 110 and the electrodes 130. Since the chemical reaction between the transparent electrodes 110 and the electrodes 130 does not occur, it is possible to maintain the resistance between the transparent electrodes 110 and the electrodes 130 constant, and it is possible to prevent the physical properties of the transparent electrodes 110 from being changed by the presence of a solvent and the like included in the electrodes 130. Further, since the anisotropic conductive adhesion layer 120 itself has strong adhesivity, it is possible to prevent the electrodes 130 from becoming separated therefrom, so that a touch panel 100 having excellent durability can be realized.

Meanwhile, referring to FIG. 3, the anisotropic conductive adhesion layer 120 may be formed of an anisotropic conductive film (ACF) or an anisotropic conductive adhesive (ACA). The ACF or ACA includes an adhesive material layer 123 and conductive balls 125 dispersed in the adhesive material layer 123. Therefore, the transparent electrodes 110 and the electrodes 130 are electrically connected with each other by the conductive balls 125.

Further, referring to FIGS. 4A and 4B, first, the anisotropic conductive adhesion layer 120 is formed on the edges of the transparent electrodes 110, and then the electrodes 130 are formed on the anisotropic conductive adhesion layer 120 (refer to FIG. 4A). Then, when the portion of the anisotropic conductive adhesion layer 120, provided with the electrodes 130, is pressed in a direction perpendicular to the transparent electrodes 110, the conductive balls 125 adhere closely to each other in the portion of the anisotropic conductive adhesion layer 120, provided with the electrodes 130, and are disposed at predetermined intervals in the portion of the anisotropic conductive adhesion layer 120, not provided with the electrodes 130 (refer to FIG. 4B). For this reason, electrical current can flow through the portion of the anisotropic conductive adhesion layer 120, provided with the electrodes 130, but not through the other portion thereof, not provided with the electrodes 130. Therefore, the anisotropic conductive adhesion layer 120 has electrical conductivity in a direction perpendicular to the transparent electrodes 110, but has no electrical conductivity in a direction parallel to the transparent electrodes 110. Accordingly, even though the anisotropic conductive adhesion layer 120 is integrally formed such that it comes into contact with a plurality of patterns 113 and 115 of the transparent electrodes 110 while it is not additionally formed with respect to each of the patterns 113 and 115 of the transparent electrodes 110, the electrode 130 is electrically connected with only the pattern 113 of the transparent electrode 110 corresponding to the electrode 130, and is not electrically connected with other pattern 115 of the transparent electrode 110. As such, since the anisotropic conductive adhesion layer 120 is integrally formed, the cost for manufacturing the touch panel 100 can be reduced, and the process for manufacturing the touch panel 100 can be simplified.

The electrodes 130, which serve to receive electrical signals form the transparent electrodes 110, are formed on the anisotropic conductive adhesion layer 120. Here, as described above, the electrodes 130 must be electrically connected with the transparent electrodes 110 through the anisotropic conductive adhesion layer 120 because the chemical reaction occurs when the electrodes 130 directly come into contact with the transparent electrodes 110. Here, the electrodes 130 may be made of silver paste or organic silver having high electrical conductivity, but the present invention is not limited thereto. That is, the electrodes 130 may also be made of conductive polymers, carbon black (including CNT), metal oxides such as ITO, or low-resistance metals. Further, it is shown in the drawings that each of the electrodes 130 is connected to both ends of each of the transparent electrodes 110 (refer to FIG. 2), which is set forth to illustrate the present invention, but may be connected to only one end thereof.

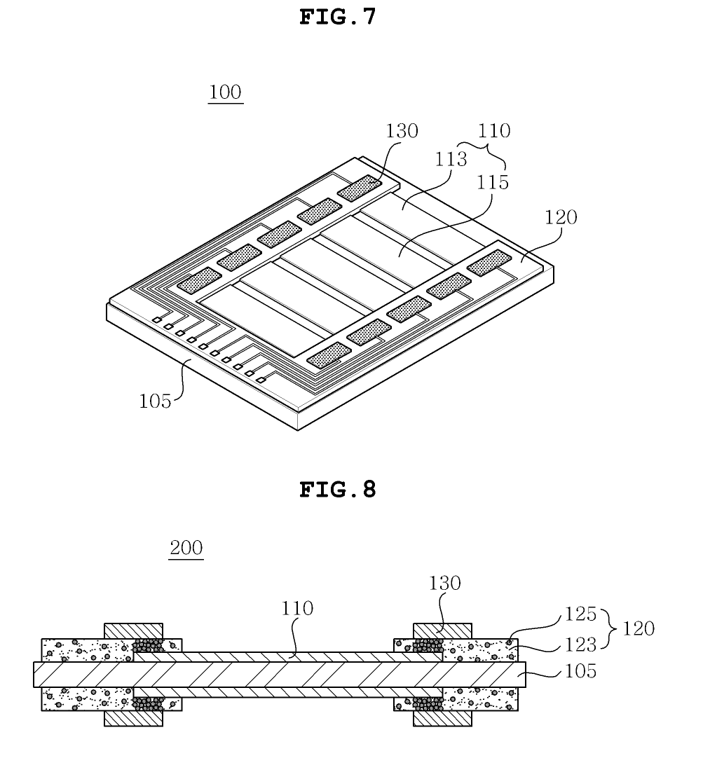

FIGS. 5 to 7 are perspective views sequentially showing a method of manufacturing a touch panel according to an embodiment of the present invention.

As shown in FIGS. 5 to 7, the method of manufacturing a touch panel according to an embodiment of the present invention includes: (A) forming transparent electrodes 110 made of a conductive polymer on one surface of a transparent substrate 105; (B) forming an anisotropic conductive adhesion layer 120 on the edges of the transparent electrodes 110; and (C) forming electrodes 130 on the anisotropic conductive adhesion layer 120 such that the electrodes 130 are electrically connected with the transparent electrodes 110 by the anisotropic conductive adhesion layer 120.

First, as shown in FIG. 5, the transparent electrodes 110 are formed on one surface of the transparent substrate 105. Here, the transparent electrodes 110 may be made of a conductive polymer, such as poly-3,4-ethylenedioxythiophene/polystyrenesulfonate (PEDOT/PSS), polyaniline, polyacetylene, polyphenylenevinylene or the like, as well as commonly-used indium tin oxide (ITO). In this case, the transparent electrodes 110 may be formed using a dry process such as sputtering, evaporation or the like, a wet process such as dip coating, spin coating, roll coating, spray coating or the like, or a direct patterning process such as screen printing, gravure printing, ink-jet printing or the like. In addition, the transparent electrodes 110 may be attached onto the transparent substrate 105 using an optical clear adhesive (OCA) after they are formed in the form of a film.

Subsequently, as shown in FIG. 6, the anisotropic conductive adhesion layer 120 is formed on the edges of the transparent electrodes 110. Here, the anisotropic conductive adhesion layer 120 may be formed of an anisotropic conductive film (ACF) or an anisotropic conductive adhesive (ACA). In this case, the anisotropic conductive film (ACF) may be directly applied thereon because it is a film, and the anisotropic conductive adhesive (ACA) may be applied thereon using screen printing because it is an adhesive. The applied anisotropic conductive film (ACF) may be dried for 15˜60 minutes. As described above, the anisotropic conductive adhesion layer 120 has electrical conductivity in a direction perpendicular to the transparent electrodes 110, but has no electrical conductivity in a direction parallel to the transparent electrodes 110. Therefore, since the anisotropic conductive adhesion layer 120 is integrally formed such that it comes into contact with a plurality of patterns 113 and 115 of the transparent electrodes 110, the cost for manufacturing the touch panel 100 can be reduced, and the process for manufacturing the touch panel 100 can be simplified.

Subsequently, as shown in FIG. 7, the electrodes 130 are formed on the anisotropic conductive adhesion layer 120. Here, the electrodes 130 are electrically connected with the transparent electrodes 110 only by the anisotropic conductive adhesion layer 120. That is, the anisotropic conductive adhesion layer 120 serves to prevent the electrodes 130 and the transparent electrodes from directly coming into contact with each other, thereby preventing the chemical reaction between the transparent electrodes 110 and the electrodes 130 from occurring. Therefore, the resistance between the transparent electrodes 110 and the electrodes 130 can be maintained constant, and the change in physical properties of the transparent electrodes 110 can be prevented. Further, since the anisotropic conductive adhesion layer 120 itself has strong adhesivity, it is possible to prevent the electrodes 130 from becoming separated therefrom, thus realizing a touch panel 100 having excellent durability.

Meanwhile, the electrodes 130 may be formed using screen printing, gravure printing, inkjet printing or the like. That is, the electrodes 130 are formed on the anisotropic conductive adhesion layer 120, and then the anisotropic conductive adhesion layer 120 is pressed such that it has electrical conductivity in a direction to perpendicular to the transparent electrodes 110. In this case, when the anisotropic conductive adhesion layer 120 is formed of an anisotropic conductive film (ACF), it may be pressed by a pressure of 1˜5 Mpa, and when the anisotropic conductive adhesion layer 120 is formed of an anisotropic conductive adhesive (ACA), it may be pressed by a pressure of 2˜4 Mpa. Further, the anisotropic conductive film (ACF) or anisotropic conductive adhesive (ACA) may be heated to 100˜150 to be cured at low temperature or may be heated to 200 or higher to be rapidly cured.

As shown in FIG. 3, according to the embodiment of the present invention, self capacitive touch panels or mutual capacitive touch panels can be fabricated using the single-layer transparent electrodes 110, and, as described later, various types of touch panels 200, 300 and 400 including the above structure can also be fabricated.

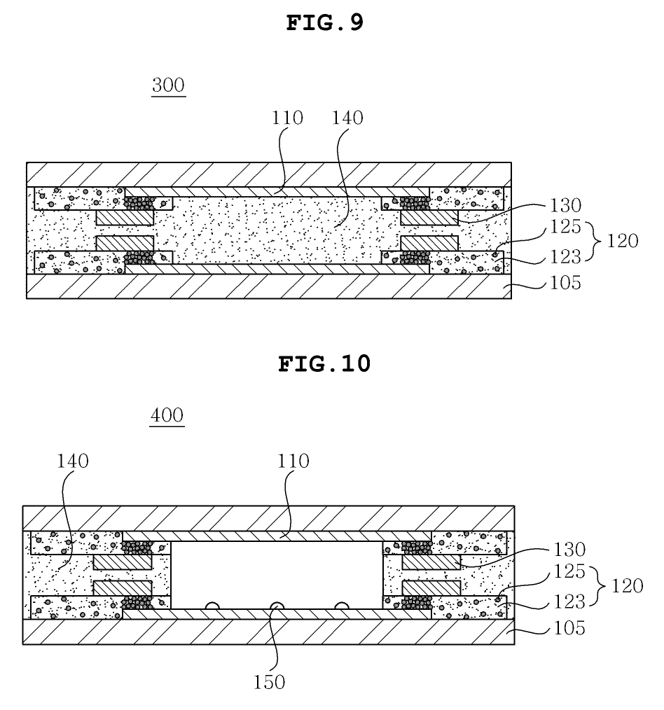

FIGS. 8 to 10 are sectional views showing touch panels according to other embodiments of the present invention.

As shown in FIG. 8, a mutual capacitive touch panel 200 (refer to FIG. 8) may be manufactured by forming transparent electrodes 110 on both surfaces of a transparent substrate 105. Further, as shown in FIGS. 9 and 10, a mutual capacitive touch panel 300 (refer to FIG. 9) and a resistive touch panel 400 (refer to FIG. 10) may be respectively manufactured by attaching two transparent substrates 105, one surface of each being provided with transparent electrodes 110, to each other such that the transparent electrodes 110 face each other. Here, in the case of mutual capacitive touch panel 300 (refer to FIG. 9), an adhesive layer 140 is entirely disposed between two transparent electrodes such that the two transparent electrodes 110 facing each other are isolated from each other. In contrast, in the case of the resistive touch panel 400 (refer to FIG. 10), an adhesive layer 140 is disposed only at the edge between two transparent electrodes such that the two transparent electrodes 110 facing each other are brought into contact with each other when the resistive touch panel 400 is pressed by a user, and dot spacers 150 are disposed on the exposed surface of each of the two transparent electrodes 110 such that the two transparent electrodes 110 return to their original positions when the pressure applied by the user is removed.

Since each of the touch panels 200, 300 and 400 according to another embodiment of the present invention also includes the anisotropic conductive adhesion layer 120 disposed between the transparent electrodes 110 and the electrodes 130, the chemical reaction between the transparent electrodes 110 and the electrodes 130 can be prevented, so that the resistance between the transparent electrodes 110 and the electrodes 130 can be maintained constant and the change in physical properties of the transparent electrodes 110 can be prevented.

As described above, the touch panel according to the present invention is advantageous in that the anisotropic conductive adhesion layer is disposed between the transparent electrodes and the electrodes, so that the chemical reaction between the transparent electrodes and the electrodes can be prevented, with the result that the resistance between the transparent electrodes and the electrodes can be maintained constant and the change in physical properties of the transparent electrodes can be prevented.

Further, the touch panel according to the present invention is advantageous in that the anisotropic conductive adhesion layer itself has strong adhesivity, so that it is possible to prevent the electrodes from becoming separated therefrom, thereby realizing a touch panel having excellent durability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A touch panel, comprising:
a transparent substrate;
a transparent electrode made of a conductive polymer and formed on one surface of the transparent substrate;
an anisotropic conductive adhesion layer formed on an edge of the transparent electrode; and
an electrode formed on the anisotropic conductive adhesion layer and electrically connected with the transparent electrode by the anisotropic conductive adhesion layer.

2. The touch panel according to claim 1, wherein the conductive polymer includes poly-3,4-ethylenedioxythiophene/polystyrenesulfonate (PEDOT/PSS), polyaniline, polyacetylene, and polyphenylenevinylene.

3. The touch panel according to claim 1, wherein the anisotropic conductive adhesion layer is formed using an anisotropic conductive film (ACF) or an anisotropic conductive adhesive (ACA).

4. The touch panel according to claim 1, wherein the anisotropic conductive adhesion layer serves to prevent the transparent electrode and the electrode from directly coming into contact with each other.

5. The touch panel according to claim 1, wherein the anisotropic conductive adhesion layer is integrally formed such that it comes into contact with a plurality of patterns of the transparent electrode, and has electrical conductivity only in a direction perpendicular to the transparent electrode.

6. A method of manufacturing a touch panel, comprising:
forming a transparent electrode made of a conductive polymer on one surface of a transparent substrate;
forming an anisotropic conductive adhesion layer on an edge of the transparent electrode; and
forming an electrode on the anisotropic conductive adhesion layer such that the electrode is electrically connected with the transparent electrode by the anisotropic conductive adhesion layer.

7. The method according to claim 6, wherein, in the forming of the transparent electrode, the conductive polymer includes poly-3,4-ethylenedioxythiophene/polystyrenesulfonate (PEDOT/PSS), polyaniline, polyacetylene, and polyphenylenevinylene.

8. The method according to claim 6, wherein, in the forming of the anisotropic conductive adhesion layer, the anisotropic conductive adhesion layer is formed by applying an anisotropic conductive film (ACF).

9. The method according to claim 6, wherein, in the forming of the anisotropic conductive adhesion layer, the anisotropic conductive adhesion layer is formed by screen-printing an anisotropic conductive adhesive (ACA).

10. The method according to claim 6, wherein, in the forming of the electrode, the anisotropic conductive adhesion layer serves to prevent the transparent electrode and the electrode from directly coming into contact with each other.

11. The method according to claim 6, wherein the anisotropic conductive adhesion layer is integrally formed such that it comes into contact with a plurality of patterns of the transparent electrode, and has electrical conductivity only in a direction perpendicular to the transparent electrode.
